(19) United States
(12) Patent Application Publication
(10) Pub. No.: US 2016/0196336 A1
(43) Pub. Date: Jul. 7, 2016

(54) Cognitive Interactive Search Based on Personalized User Model and Context

(71) Applicant: International Business Machines Corporation, Armonk, NY (US)

(72) Inventors: Corville O. Allen, Morrisville, NC (US); Laura J. Rodriguez, Durham, NC (US)

(21) Appl. No.: 14/588,547

(22) Filed: Jan. 2, 2015

(51) Int. Cl. G06F 17/30

(52) U.S. Cl. CPC G06F 17/30675; G06F 17/30696; G06F 17/30654; G06F 17/30867

(57) ABSTRACT

Mechanisms, in a Question and Answer (QA) system, are provided for performing a personalized context based search of a corpus of information. A question is received, by the QA system, from a first user via a source device. A first user profile associated with the first user, which specifies a personality trait of the first user, is retrieved. First candidate answers to the original question are generated based on a search of a corpus and second users having a similar personality trait to the personality trait of the first user are identified. Similar questions to that of the original question, which were previously submitted to the QA system by the one or more second users are identified. Second candidate answers based on the one or more similar questions are generated by the QA system. A final answer based on the first candidate answers and the second candidate answers is generated and output to the user via the source device.

### BACKGROUND

The present application relates generally to an improved data processing apparatus and method and more specifically to mechanisms for performing a cognitive interactive search based on a personalized user model and a context.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

Examples, of QA systems are Siri® from Apple®, Cortana® from Microsoft®, and the IBM Watson™ system available from International Business Machines (IBM®) Corporation of Armonk, N.Y. The IBM Watson™ system is an application of advanced natural language processing, information retrieval, knowledge representation and reasoning, and machine learning technologies to the field of open domain question answering. The IBM Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

### SUMMARY

In one illustrative embodiment, a method is provided, in a data processing system implementing a Question and Answer (QA) system, for performing a personalized context based search of a corpus of information. The method comprises receiving, by the QA system, from a first user via a source device, an original question for processing by the QA system to generate an answer result. The method further comprises retrieving, by the QA system, a first user profile associated with the first user. The first user profile specifies a personality trait of the first user. The method also comprises generating, by the QA system, one or more first candidate answers to the original question based on a search of a corpus of electronic content and identifying, by the QA system, one or more second users having a similar personality trait to the personality trait of the first user. Moreover, the method comprises identifying, by the QA system, one or more similar questions, similar to that of the original question, previously submitted to the QA system by the one or more second users and generating, by the QA system, one or more second candidate answers based on the one or more similar questions. Furthermore, the method comprises generating, by the QA system, a final answer based on the one or more first candidate answers and one or more second candidate answers and outputting, by the QA system, the answer to the user via the source device.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QA) system in a computer network;

FIG. 2 is a block diagram of an example data processing system in which aspects of the illustrative embodiments are implemented;

FIG. 3 illustrates a QA system pipeline for processing an input question in accordance with one illustrative embodiment; and

FIG. 4 is a flowchart outlining an example operation of a query expansion engine in accordance with one illustrative embodiment.

### DETAILED DESCRIPTION

The illustrative embodiments provide mechanisms for performing a cognitive interactive search based on a personalized user model and a context. The illustrative embodiments augment a search of a corpus for an answer to a question or request by finding previously successfully completed searches of the corpus that are semantically and syntactically similar and associated with users having similar personality traits to an originating user submitting the current search request or question, or that are logically connected with the originating user via one or more common contexts. Contexts associated with the originating user, and users with which the originating user is connected or which have similar personality traits, may further be maintained and used to identify a scope of the corpus used to provide results of the search and/or question answering.

In one aspect of the illustrative embodiments, a request for a search or a question (hereafter referred to as a “question” for processing by a Question and Answer (QA) system, such as the IBM Watson™ QA system available from International Business Machines (IBM) Corporation of Armonk, N.Y.) is received from an originating user. The question is analyzed using Natural Language Processing (NLP) mechanisms to extract features of the question including a focus, a lexical answer type, semantic information (i.e. information relating to the meaning of words), syntactic information (i.e. information relating to the manner by which words are put together for form sentences), and the like. These features are compared to features of previously submitted questions that were successfully answered (hereafter referred to as “previously submitted successful questions”) to identify previously used terms/phrases in these other previously submitted questions based on the context of the original question and the relevance of the other previously submitted questions that were successfully answered.

Moreover, a user profile for the originating user is retrieved or generated that identifies the personality traits of the user. Terms/phrases in the other previously submitted successful questions are selected based on their alignment with the personality traits of the originating user. Supplemental queries are applied against a corpus based on the selected terms/phrases from the previously submitted successful questions which also align with the personality traits of the originating user. The results of these queries are used to augment the results of the processing of the original question and generate a corresponding set of candidate answers from which a final answer is selected.

In some illustrative embodiments, an interactive exchange between the QA system and a client device of the originating user is performed so as to provide to the originating user a listing of potential alternative or additional terms/phrases to be used to generate the additional queries and optionally the reasoning why these terms/phrases are being presented as alternatives. The originating user may select from the listing those terms/phrases that the originating user believes are relevant to the original question posed and the type of answer the originating user wishes to receive.

In operation an originating user submits an original question to the QA system as mentioned above. The originating user's profile is retrieved and the personality traits associated with the originating user's profile are identified. In addition, the user's profile specifies various contexts and actions taken within each context within a predefined historical time frame, e.g., the last 30 days, last week, or the like. For example, various contexts of the type such as forums, blogs, files, network activity, electronic mail, Wiki pages, and the like may be maintained in association with the user's profile. Within each context, information about the activities of the user within that context is stored. The information may comprise, for example, for a forum context, messages posted to forums along with timestamps and identifiers of forum message strings. For a files context, information about the files accessed by the user within the historical time frame may be stored in association with the files context. Other types of context information for various contexts may be maintained in association with the user profile.

The original question is analyzed to identify the features of the original question and the features are associated with regard to each of the possible contexts associated with the originating user's profile to identify which contexts the features correspond to. Thus, for example, if the user submits an original question of the type “What was the file I worked on last week with Dave's comment in it,” the term “file” may be analyzed and correlated with the “files” context associated with the originating user's profile and the term “last week” may be used to specify a historical time frame context. The term “Dave” may be used to identify other connected users, i.e. users that have a relationship with the originating user in some way. Key terms/phrases in the features of the question may be compared to the terms/phrases associated with each of the contexts of the original user's profile to identify the contexts with which the terms/phrases of the features correspond. Other terms within the matching contexts which are similar to the terms/phrases of the features of the original question may be identified, e.g., “file” is similar to other terms in the various contexts including “documents,” “pages,” “Wiki pages,” “Emails,” “electronic mails,” etc. These similar terms/phrases may then be used to generate additional queries to be applied to the corpus to generate candidate answers. Thus, features of the original question may be compared to various contexts to identify other terms/phrases that may be used within those contexts to augment the results generated by the processing of the original question. Thus, the original question is used to generate queries to be applied against the corpus, and additional queries are generated through the identification of similar terms/phrases from various contexts and are applied against the corpus, to generate a set of candidate answers from which a final answer is selected.

In addition, in some illustrative embodiments, the features of the original question and the personality traits of the originating user may be utilized to identify other similar users that submitted similar questions which were successfully answered as well. Similar users may be users that have a pre-existing specifically defined connection with the originating user, e.g., other users that are designated “friends,” co-workers, relatives, or the like with the originating user via an organization computing system, social networking website, or the like that is part of the corpus or part of a configuration data structure used by the QA system. Similar users may further be users identified either through the configuration information for the QA system, or through searching user data structures of a corpus, and comparison of personality traits. In this way, the users that are connected to the originating user or that have similar personality traits are identified.

Having identified users that are connected to the user either through a specified relationship or through similar personality traits, similar questions submitted by these connected users, as may be maintained in a history data structure associated with the user profiles of these connected users, are identified through a comparison of features of the original question to questions previously submitted by the connected users. The final answers associated with these similar questions may then be used as part of the evaluation of candidate answers for the generation of a final answer. The final answers may be those candidate answers actually selected by the connected users in response to the output of candidate answers to these previously submitted questions. Thus, these candidate answers from the previously submitted questions of the connected users may be ranked in association with the candidate answers generated by the processing of the original question and the expansion of the features of the original question using similar features in the various contexts associated with the originating user profile.

In some illustrative embodiments, similar questions of the connected users may be selected only from those contexts that are the same as the contexts with which the original question is associated through the process mentioned above. Thus, a subset of the previously submitted questions of the connected users, in contexts determined to be related to the original question, may be evaluated to identify similar questions and their corresponding answers. These corresponding answers may be used to augment the candidate answers generated through the processing of the original question and its expansion with similar features in the related contexts.

In still further illustrative embodiments, the output of the answering of the question is customized to the particular originating user's personality traits. That is, the QA system is configured with a set of pre-defined personality traits which have associated characteristics indicative of the types of information that a user having that particular personality trait is most likely interested in. Thus, for example, an extroverted individual is much more interested in information relating to relationships between elements rather than details of a particular event, e.g., an extrovert is more interested in who accessed a file than what that person specifically did when accessing the file. Thus, if an input question were of the type “What accesses to my files occurred last week?” the answer for an extroverted person may be of the type “Dave and Mary accessed your files last week” whereas a detail-oriented conscientious person may receive an answer of the type “Dave edited file mydoc01.doc on Nov. 28, 2014 at 5:03 pm.”

The illustrative embodiments may comprise answer output logic that identifies the supporting evidence for a final answer and determines what level of detail to use from the supporting evidence, and a formulation of the output of the final answer to present, based on the originating user's personality trait(s). The resulting formulation of the output of the final answer may then be returned to the originating user such that the originating user receives the final answer in a form that will more likely resonate with the originating user's personality type.

For example, in one illustrative embodiment, the mechanisms of the illustrative embodiment process a set of personality traits associated with the originating user and selects the most dominant trait values to use in determining what level and type of supporting evidence to select for use in generating the output of the final answer, as well as for use in the scoring of the final answers. The mechanisms of the illustrative embodiment then, based on the dominant personality traits, parse the annotations in the supporting evidence for the candidate answers and weights candidate answers that have annotation types that align with the dominant personality traits relatively higher.

A ranked listing of candidate answers may then be generated based on the weighted scoring of the candidate answers and a final answer may be selected from the ranked listing. The supporting evidence associated with the final answer may then be parsed to choose information, sentences, metadata, or the like, that aligns with the dominant personality traits of the user. The selected portions of the supporting evidence may then be returned as part of the output of the final answer by including the portions of supporting evidence as part of the natural language output of the final answer, such as in the form of underlying reasoning expressions included in the natural language output of the final answer.

For example, if the original question received is about files (e.g., “What accesses to my files occurred last week?”), for an extrovert the candidate answers may include several similar files in different areas, however a single file accessed last week may be selected as the top ranking final answer. The supporting evidence for this final answer may include annotations for persons, annotations for actions, verbs in sentences that have the file as objects, e.g., Subject-Verb Object (SVO), and annotations on the environment in which the file was accessed or changed, e.g., edited via “Wiki Editor” and uploaded a new version via File Manager. The types of annotations that would be aligned with an extrovert, in one illustrative embodiment, may include the set of persons, places, meetings, and these the like, and may be returned with the answer. The types of annotations associated with a conscientious person, on the other hand, may be any verb actions on the particular object in the question or the lexical answer types in the question, the type of environment that the actions took place in, and where the actions may have taken place and when. This information may be included in the supporting evidence for the answers, or the answers themselves may include these types of annotations.

In some illustrative embodiments, a machine learning model is utilized to learn the weights and applicability of different personality traits towards certain features (annotations) found in supporting evidence and candidate answer texts to better align with a particular personality trait. This machine learning model may be used within the QA system to help rank candidate answers based on the supporting evidence for candidate answers as noted above and discussed in greater detail hereafter.

Thus, as a summary, in an illustrative embodiment that incorporates all of the various elements of the embodiments described above, the following operations are performed:
1. The original question is received and processed to extract features of the original question and generate queries based on the extracted features.
2. A user profile for the originating user that submitted the original question is retrieved to identify connected users and personality traits of the originating user.
3. The features of the original question are compared to pre-defined contexts associated with the user profile to identify pre-defined contexts with which the features are associated and personality traits with which the features are associated. For example, a pre-defined context may be a social online document collaboration environment similar to IBM Connections Community or Drop Box online community, where the features include wiki, document repository, people, events, tasks, and blogs. These contexts, and their defining characteristics, are associated with features which are then aligned to a particular personality trait or profile type. For example, people and events may be associated with the personality trait “extrovert,” while blogs are associated with both extraverts and openness personality traits. Another pre-defined context may be an electronic mail client where the senders and receivers are predominantly favored for extrovert type personality traits, while the content of the electronic mail messages are associated with conscientious personality traits and the social feedback items (e.g., “likes,” “thumbs up,” user ratings, etc.) are associated with an “agreeableness” personality trait.
4. Similar features in the identified pre-defined contexts are identified and used to generate queries and annotations to be applied to the corpus. For example, a “like” social tag found in the corpus may be annotated with an alignment to the set of personality traits that match, for example “agreeableness”.
5. Processing of the extracted features of the original question and the similar features in the related contexts are applied to a corpus to generate candidate answers, confidence scores, and supporting evidence passages.
6. Corresponding contexts of connected users and/or users having similar personality traits are searched for previously submitted questions having similar features and final answers related to these similar questions are retrieved and evaluated in association with the candidate answers generated in 5) above. For example, a repository of searches may be stored in a database where the dominant personality traits of the users are associated with the search results, including which result was clicked and the top set of features from the search. For example, a question of the type “What occurred with my files last week?” may be searched, and the top three answers may include (A) “Dave and Mary accessed your files last week”, (B) “Dave edited file mydoc01.doc on Nov. 28, 2014 at 5:03 pm”, and (C) “Mike uploaded a new version of myDoc02.doc file from File Manager.” It may be determined from the repository that users with dominant extrovert traits chose (A) most often, or similar results around the same type of questions, while users with conscientious traits choose (B) and sometimes (C) more often. These characteristics and features from NLP parsing and feature extraction are associated with the search results and how many times the particular result (answer) was chosen by the user to better prioritize results for a particular personality trait.
7. A final answer is selected from a ranked listing of all of the candidate answers.
8. A content and formulation of the final answer is generated based on the originating users' personality trait(s), the final answer itself, and the supporting evidence of the final answer.
9. The final answer formulation is output to the originating user's client device for output to the originating user as the answer to the original question.

Thus, the processing of the original question may be expanded based on the contexts associating with the user profile of an originating user and other users connected to the originating user either through specified connections or through similarity of personality traits. Moreover, the output of the answer to a question may be specifically customized to the particular personality traits of the originating user such that the output contains the type of information and formulation that a person having the personality traits of the originating user is likely to resonate with. Hence, overall, a more accurate question answering mechanism is provided that further provides a better experience for the originating user by providing answers in a way that is more likely to resonate with that user's own specific personality traits.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

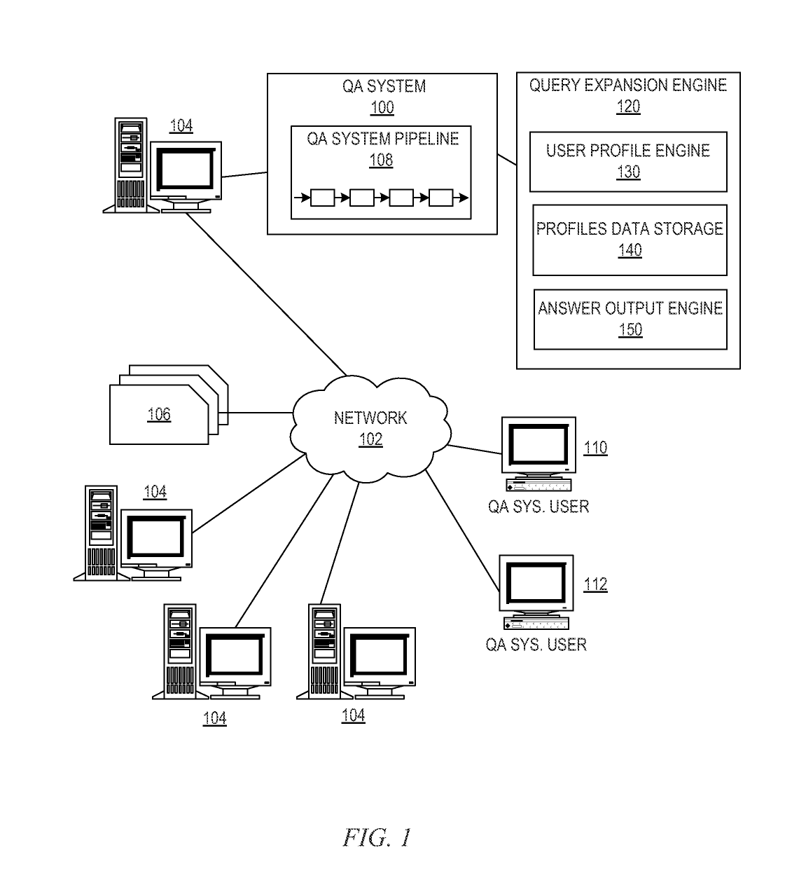

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example Question Answering (QA) system (also referred to as a Question/Answer system or Question and Answer system), methodology, and computer program product with which the mechanisms of the illustrative embodiments are implemented. As will be discussed in greater detail hereafter, the illustrative embodiments are integrated in, augment, and extend the functionality of these QA mechanisms with regard to expanding searches for candidate answers based on one or more personalized contexts associated with a user as well as connected users having predefined relationships and/or similar personality traits. Moreover, the QA mechanisms are augmented to also customize the output of a final answer to the originating user according to the originating user's personality trait(s).

Since the illustrative embodiments improve QA mechanisms, it is important to first have an understanding of how question and answer creation in a QA system is implemented before describing how the mechanisms of the illustrative embodiments are integrated in and augment such QA systems. It should be appreciated that the QA mechanisms described in FIGS. 1-3 are only examples and are not intended to state or imply any limitation with regard to the type of QA mechanisms with which the illustrative embodiments are implemented. Many modifications to the example QA system shown in FIGS. 1-3 may be implemented in various embodiments of the present invention without departing from the spirit and scope of the present invention.

As an overview, a Question Answering system (QA system) is an artificial intelligence application executing on data processing hardware that answers questions pertaining to a given subject-matter domain presented in natural language. The QA system receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system. The document may include any file, text, article, or source of data for use in the QA system. For example, a QA system accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to the QA system which then answers the input questions using the content in the corpus of data by evaluating documents, sections of documents, portions of data in the corpus, or the like. When a process evaluates a given section of a document for semantic content, the process can use a variety of conventions to query such document from the QA system, e.g., sending the query to the QA system as a well-formed question which are then interpreted by the QA system and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA system receives an input question, parses the question to extract the major features of the question, uses the extracted features to formulate queries, and then applies those queries to the corpus of data. Based on the application of the queries to the corpus of data, the QA system generates a set of hypotheses, or candidate answers to the input question, by looking across the corpus of data for portions of the corpus of data that have some potential for containing a valuable response to the input question. The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model is used to summarize a level of confidence that the QA system has regarding the evidence that the potential response, i.e. candidate answer, is inferred by the question. This process is repeated for each of the candidate answers until the QA system identifies candidate answers that surface as being significantly stronger than others and thus, generates a final answer, or ranked set of answers, for the input question.

As mentioned above, QA systems and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA system. Content creators, automated tools, or the like, annotate or otherwise generate metadata for providing information useable by the QA system to identify these question and answer attributes of the content.

Operating on such content, the QA system generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a question/answer creation (QA) system 100 in a computer network 102. One example of a question/answer generation which may be used in conjunction with the principles described herein is described in U.S. Patent Application Publication No. 2011/0125734, which is herein incorporated by reference in its entirety. The QA system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The QA system 100 and network 102 enables question/answer (QA) generation functionality for one or more QA system users via their respective computing devices 110-112. Other embodiments of the QA system 100 may be used with components, systems, sub-systems, and/or devices other than those that are depicted herein.

The QA system 100 is configured to implement a QA system pipeline 108 that receive inputs from various sources. For example, the QA system 100 receives input from the network 102, a corpus of electronic documents 106, QA system users, and/or other data and other possible sources of input. In one embodiment, some or all of the inputs to the QA system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the QA system 100 may operate in environments of any size, including local and global, e.g., the Internet.

In one embodiment, the content creator creates content in a document of the corpus of data 106 for use as part of a corpus of data with the QA system 100. The document includes any file, text, article, or source of data for use in the QA system 100. QA system users access the QA system 100 via a network connection or an Internet connection to the network 102, and input questions to the QA system 100 that are answered by the content in the corpus of data 106. In one embodiment, the questions are formed using natural language. The QA system 100 parses and interprets the question, and provides a response to the QA system user, e.g., QA system user 110, containing one or more answers to the question. In some embodiments, the QA system 100 provides a response to users in a ranked list of candidate answers while in other illustrative embodiments, the QA system 100 provides a single final answer or a combination of a final answer and ranked listing of other candidate answers.

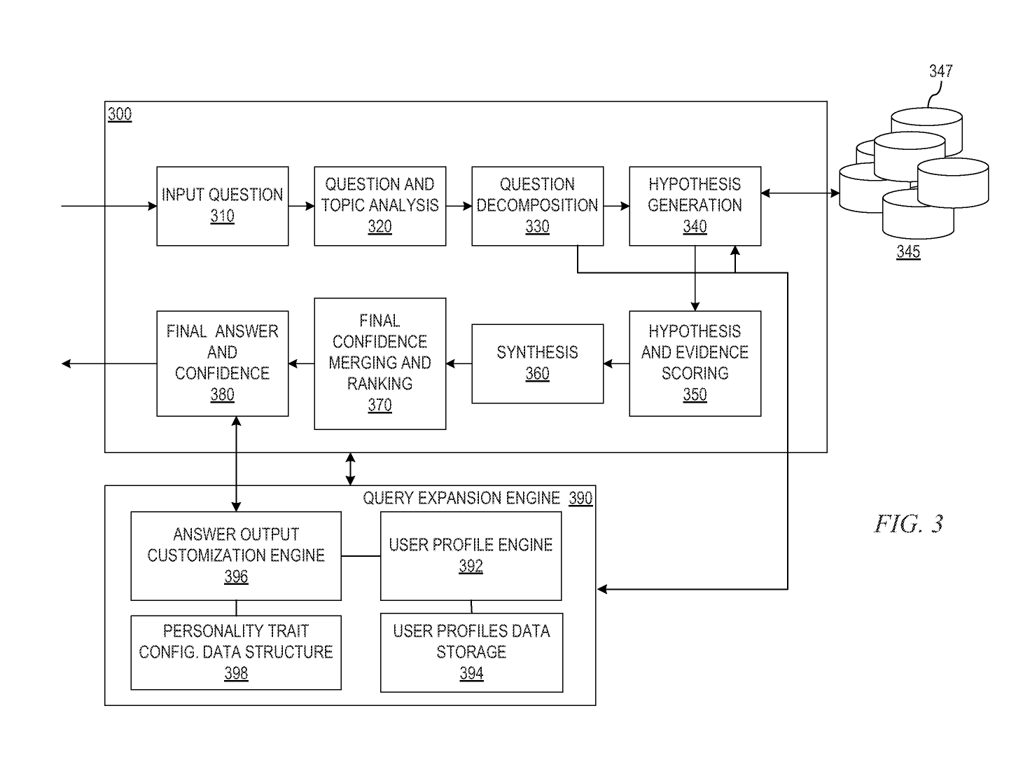

The QA system 100 implements a QA system pipeline 108 which comprises a plurality of stages for processing an input question and the corpus of data 106. The QA system pipeline 108 generates answers for the input question based on the processing of the input question and the corpus of data 106. The QA system pipeline 108 will be described in greater detail hereafter with regard to FIG. 3.

In some illustrative embodiments, the QA system 100 may be the IBM Watson™ QA system available from International Business Machines Corporation of Armonk, N.Y., which is augmented with the mechanisms of the illustrative embodiments described hereafter. As outlined previously, the IBM Watson™ QA system receives an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The IBM Watson™ QA system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the IBM Watson™ QA system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

In one aspect of the illustrative embodiments, a query expansion engine 120 is provided in association with the QA system pipeline 108 to perform operations for expanding the queries applied against the corpus and/or candidate answers considered during scoring and ranking, based on personalized contexts of an originating user and/or users that are connected to the originating user (the “originating user” is the user that submits the initial natural language request or question that is processed by the QA system 100).

The query expansion engine 120 works in conjunction with a user profile engine 130 that operates on user profiles data storage 140 to identify a user profile for an originating user that submits an original input question and to identify user profiles of connected users. The original question is received and processed to extract features of the original question and generate queries based on the extracted features. A user profile in the profiles data storage 140 for the originating user that submitted the original question is retrieved by the user profile engine 130 to identify connected users and personality traits of the originating user. For example, a user profile of the originating user may specify contexts associated with the user, key terms/phrases, previous questions and answers, and the like, associated with these contexts, and personality trait(s) of the user, as well as identifiers of other users with which the originating user has an affiliation, e.g., occupational relationship, family relationship, friend relationship, or the like. This information may all be identified by the user profile engine 130 in response to retrieving the user's profile from the user profiles data storage 140, such as by performing a search or lookup of the user's profile based on a user identifier or other unique identifier.

In some illustrative embodiments, the user's profile specifies, in association with these various contexts, actions taken within each context within a predefined historical time frame, e.g., the last 30 days, last week, or the like. For example, various contexts of the type such as forums, blogs, files, network activity, electronic mail, Wiki pages, and the like may be maintained in association with the user's profile. Within each context, information about the activities of the user within that context is stored. The information may comprise, for example, for a forum context, messages posted to forums along with timestamps and identifiers of forum message strings. For a files context, information about the files accessed by the user within the historical time frame may be stored in association with the files context. Other types of context information for various contexts may be maintained in association with the user profile.

The original question is analyzed to identify the features of the original question and the features are associated with regard to each of the possible contexts associated with the originating user's profile to identify which contexts the features correspond to. The features of the original question are compared, by the query expansion engine 120 to pre-defined contexts associated with the user profile to identify pre-defined contexts with which the features are associated. This comparison allows the system to formalize and choose candidate answers that are from within the same context as the original question (the context of the original question may be determined from additional information submitted with the original question, from a source of the original question, or may be associated with the target corpus of the original question, for example), or more aligned with the type of context that the user is most likely interested. This comparison further allows for better correlated answers within the environment which would be more useful to a user. For example, within a social collaborative environment the answers with actual file names and people are typically automatically converted via hyperlinks and thus, answers with this hyperlink information would be better aligned to that particular environment. This comparison also allows for easy navigation or output of tooltips for items in that environmental context once the answers are returned. The same question executed from a single user's email client, on the other hand, contains primarily the dates, the sender, recipients, and the people who responded which aligns better with that environment. Allowing for easy use to respond or reply to an email communication. Similar features, as may be determined from term/phrase matching, synonym matching, or the like, in the identified pre-defined contexts are identified and used to generate queries to be applied to the corpus. In some illustrative embodiments, an interactive exchange between the QA system and a client device 112 of the originating user is performed so as to provide to the originating user a listing of potential alternative or additional terms/phrases to be used to generate the additional queries and optionally the reasoning why these terms/phrases are being presented as alternatives. The originating user may select from the listing those terms/phrases that the originating user believes are relevant to the original question posed and the type of answer the originating user wishes to receive.

Queries from the extracted features of the original question and the similar features in the related contexts are applied by the QA system pipeline 130 to a corpus to generate candidate answers, confidence scores, and supporting evidence passages. That is, supplemental queries are applied against a corpus based on the selected terms/phrases from the previously submitted successful questions which also align with the personality traits of the originating user as indicated by the contexts in the originating user's profile. The results of these queries are used to augment the results of the processing of the original question and generate a corresponding set of candidate answers.

In addition, user profiles for connected users and/or users having similar personality traits are identified by the user profile engine 130 and retrieved from the user profile data storage 140. These user profiles may be identified based on the user identifiers of connected users in the originating user's profile. These user profiles may further be identified by performing a search of the user profile data storage 140 for user profiles having the same personality trait(s) as the user profile of the originating user. The user profiles that are retrieved in this manner, i.e. the connected user profiles, are searched for corresponding contexts to those identified in the originating user's profile based on the evaluation of the extracted features from the original question.

Matching corresponding contexts of connected users and/or users having similar personality traits are searched for previously submitted questions having similar features to that of the extracted features from the original question. Final answers related to these similar questions are retrieved and evaluated in association with the candidate answers generated from the queries performed based on the original question and the expansion of those features based on the originating user's profile.

The final answers generated from these other questions from connected users are evaluated in combination with the candidate answers generated from the queries based on the original question and the expansion of its features based on the contexts of the originating user's profile. The combination of candidate answers and final answers from the connected users may be used to generate a ranked listing of candidate answers. A final answer is selected from the ranked listing of all of the candidate answers, e.g., a highest scoring answer from the ranked listing of candidate answers.

The final answer is then formulated into a response output to be sent to the originating user's client device for output to the originating user as the answer to the original question. The content and formulation of the final answer is generated by answer output engine 150 based on the originating users' personality trait(s), as identified from the originating user's profile, the final answer itself, and the supporting evidence of the final answer. For example, the answer output engine 150 may be configured with a set of pre-defined personality traits which have associated characteristics indicative of the types of information that a user having that particular personality trait is most likely interested in. As mentioned above, for example, an extroverted individual is much more interested in information relating to relationships between elements rather than details of a particular event, e.g., an extrovert is more interested in who accessed a file than what that person specifically did when accessing the file. Thus, if an input question were of the type “What accesses to my files occurred last week?”, the answer for an extroverted person may be of the type “Dave and Mary accessed your files last week” whereas a detail-oriented introvert may receive an answer of the type “Dave edited file mydoc01.doc on Nov. 28, 2014 at 5:03 pm.”

The answer output engine 150 identifies the supporting evidence for a final answer and determines what level of detail to use from the supporting evidence, and a formulation of the output of the final answer to present, based on the originating user's personality trait(s). The resulting formulation of the output of the final answer may then be returned to the originating user such that the originating user receives the final answer in a form that will more likely resonate with the originating user's personality type. The final answer formulation is output to the originating user's client device 112 for output to the originating user as the answer to the original question.

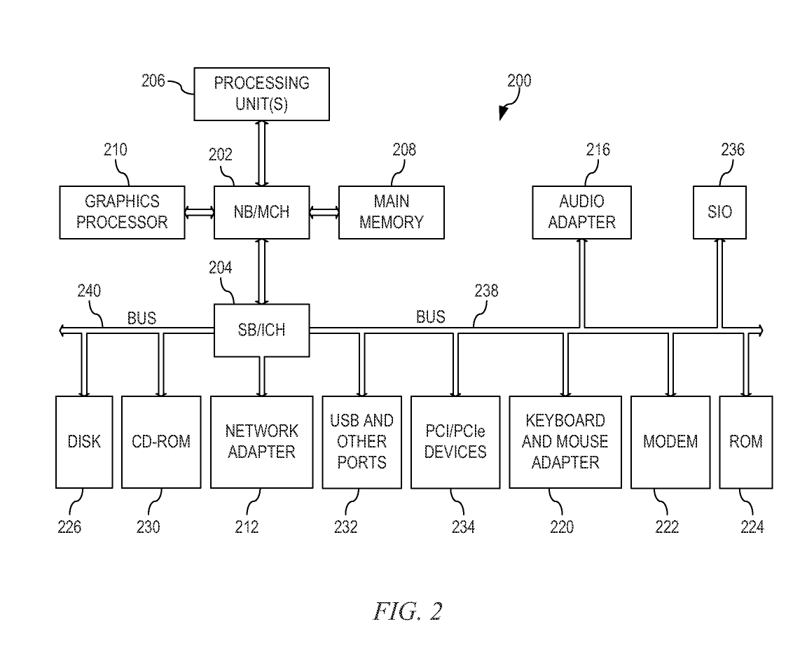

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a QA system 100 and QA system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a QA system pipeline for processing an input question in accordance with one illustrative embodiment. The QA system pipeline of FIG. 3 may be implemented, for example, as QA system pipeline 108 of QA system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user inputs, via a user interface, an input question for which the user wishes to obtain an answer, e.g., “Who are Washington's closest advisors?” In response to receiving the input question, the next stage of the QA system pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1300s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “ drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

The illustrative embodiments of the present invention augment the QA system pipeline 300 with a query expansion engine 390, user profile engine 392, user profiles data storage 394, answer output customization engine 396, and personality trait configuration data structure 398. The query expansion engine 390 comprises logic which, in accordance with one aspect of the illustrative embodiments, identifies the originating user that submitted the input question 310 and works with the user profile engine 392 to retrieve a corresponding user profile from the user profiles data storage 394. The user profile for the originating user identifies the personality traits of the originating user. In addition, the user's profile specifies various contexts and actions taken within each context within a predefined historical time frame, e.g., the last 30 days, last week, or the like. Information associated with each of the contexts may further include previous questions submitted by the user that were answered successfully and which are associated with the context, key terms/phrases extracted from questions answered successfully and which are associated with the context, and the like. Moreover, the user profile may store information about connected users and their particular connections, e.g., family relationships, friend relationships, co-worker relationships, and the like.

The original question 310 is analyzed in the manner previously described above with regard to the operation of the QA system pipeline 300 to identify/extract the features of the original question 310. The identified/extracted features are compared to the features associated with each of the contexts specified in the originating user's profile to identify which contexts the features correspond to. Thus, for example, terms/phrases extracted from the original question 310 may be compared against key terms/phrases for each of the contexts of the originating user's profile to determine which contexts have matching key terms/phrases, taking into account synonyms. Those contexts that have matching key terms/phrases are identified as matching contexts for the original question 310. These contexts may have other related features associated with them, e.g., other terms/phrases, which may be used to generate additional queries for expanding the processing of the original question 310. Thus, features of the original question 310 may be compared to various contexts of the originating user's profile to identify other terms/phrases that may be used within those contexts to augment the results generated by the processing of the original question 310. Thus, the original question 310 is used to generate queries to be applied against the corpora 345 or corpus 347, and additional queries are generated through the identification of similar terms/phrases from various contexts and are applied against the corpora 345 or corpus 347, to generate a set of candidate answers from which a final answer is selected. These additional queries are processed through the various appropriate stages 340-380 of the QA system pipeline 300 in the manner previous described above as if they were queries generated from features specifically extracted from the input question 310 and thus, generate additional candidate answers for inclusion in the listing of candidate answers evaluated for generation of confidence scores and ranking of candidate answers.

Features in the other previously submitted successful questions may be selected based on their alignment with the personality traits of the originating user. In some illustrative embodiments, an interactive exchange between the query expansion engine 390 and a client device of the originating user is performed so as to provide to the originating user a listing of potential alternative or additional terms/phrases to be used to generate the additional queries and optionally the reasoning why these terms/phrases are being presented as alternatives. The originating user may select from the listing those terms/phrases that the originating user believes are relevant to the original question posed and the type of answer the originating user wishes to receive.

With regard to further aspects of the illustrative embodiments, the user profile engine 392 identifies the personality traits of the originating user via the originating user's profile retrieved from the user profiles data storage 394 and uses these personality traits as well as specifically identified connected users specified in the originating user's profile to identify other similar users that submitted similar questions which were successfully answered as well. Similar users may be users that have a pre-existing specifically defined connection with the originating user, e.g., other users that are designated “friends,” co-workers, relatives, or the like with the originating user via an organization computing system, social networking website, or the like that is part of the corpus or part of a configuration data structure used by the QA system pipeline 300, e.g., the user profiles in the user profiles data storage 394. Thus, in some illustrative embodiments, rather than having to have connected users specified in the user profiles, other data structures of the organization or social networks may be searched to identify the originating user's corresponding accounts/profiles and identify other users with which the originating user interacts or is otherwise affiliated through the organization or social networking website. Similar users may further be users identified through searching user profiles of the user profile data structure 394, or other user data structures of a corpus, and comparing personality traits of these profiles to identify matching personality traits. In this way, the users that are connected to the originating user or that have similar personality traits are identified.

Having identified users that are connected to the originating user either through a specified relationship or through similar personality traits, the user profiles for these connected users may be processed to identify similar contexts specified in these user profiles to those contexts with which the features of the original question 310 were determined to be matching. For those contexts of the connected user profiles that match a context of the original question 310, the context information is processed to identify similar questions submitted by these connected users, as may be maintained in a history data structure associated with the contexts within the user profiles of these connected users. Similar questions may be identified through a comparison of features of the original question 310 to questions previously submitted by the connected users as stored in the history data structures associated with the matching contexts.

The final answers associated with these similar questions may then be returned to stage 350 of the QA system pipeline 300 for evaluation of candidate answers for the generation of a final answer to the original question 310. The final answers may be those candidate answers actually selected by the connected users in response to the output of candidate answers to these previously submitted questions. Thus, these candidate answers from the previously submitted questions of the connected users may be ranked in association with the candidate answers generated by the processing of the original question 310 through the QA system pipeline 300 and the expansion of the features of the original question 310 using similar features in the various contexts associated with the originating user profile.

The answer output customization engine 396 customizes the output of the selected final answer obtained from stage 380 based on the particular originating user's personality traits. That is, the QA system pipeline 300 is configured with a set of pre-defined personality traits, specified in the personality trait configuration data structure 398, which have associated characteristics indicative of the types of information that a user having that particular personality trait is most likely interested in, as discussed previously.

The answer output customization engine 396 identifies the supporting evidence for the final answer and determines what level of detail to use from the supporting evidence, and a formulation of the output of the final answer to present, based on the originating user's personality trait(s). The resulting formulation of the output of the final answer may then be returned to the originating user such that the originating user receives the final answer in a form that will more likely resonate with the originating user's personality type.

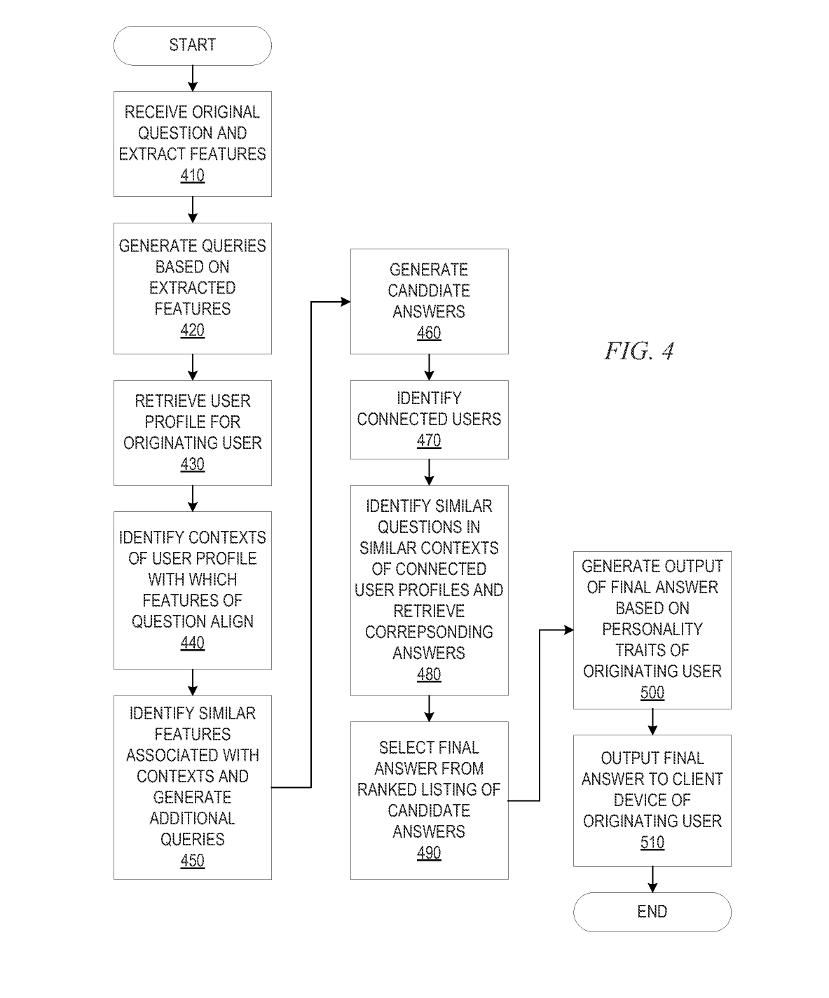

FIG. 4 is a flowchart outlining an example operation of a query expansion engine in accordance with one illustrative embodiment. As shown in FIG. 4, the operation starts with an original question being received and processed to extract features of the original question (step 410) and queries being generated based on the extracted features (step 420). A user profile for the originating user that submitted the original question is retrieved to identify user profile contexts, connected users, and personality traits of the originating user (step 430).

The features of the original question are compared to the pre-defined contexts associated with the user profile to identify pre-defined contexts with which the features are associated (step 440). Similar features in the identified pre-defined contexts are identified and used to generate queries to be applied to the corpus (step 450). Queries from the extracted features of the original question and the similar features in the related contexts are applied to a corpus to generate candidate answers, confidence scores, and supporting evidence passages (step 460). Corresponding contexts of connected users and/or users having similar personality traits are searched for previously submitted questions having similar features (step 470) and final answers related to these similar questions are retrieved and evaluated in association with the candidate answers generated in step 460 above (step 480).

A final answer is selected from a ranked listing of all of the candidate answers (step 490). The content and formulation of the final answer is generated based on the originating users' personality trait(s), the final answer itself, and the supporting evidence of the final answer (step 500). The final answer formulation is then output to the originating user's client device for output to the originating user as the answer to the original question (step 510). The operation then terminates.

Thus, the illustrative embodiments provide mechanisms for expanding the query processing performed by a QA system pipeline, or other natural language processing (NLP) system, based on the personalized contexts of an originating user. The expansion takes into consideration contexts associated with the originating user's profile, connected users, and personality traits of the originating user. The output of a final answer may also be customized to include a level of detail and formulation that is most likely of a type the originating user is wanting to receive. Thus, overall, a more accurate processing of a question with a more appropriate formulation of the answer is generated by the mechanisms of the illustrative embodiments than otherwise might be performed.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system implementing a Question and Answer (QA) system, for performing a personalized context based search of a corpus of information, comprising:
receiving, by the QA system, from a first user via a source device, an original question for processing by the QA system to generate an answer result;
retrieving, by the QA system, a first user profile associated with the first user, wherein the first user profile specifies a personality trait of the first user;
generating, by the QA system, one or more first candidate answers to the original question based on a search of a corpus of electronic content;
identifying, by the QA system, one or more second users having a similar personality trait to the personality trait of the first user;
identifying, by the QA system, one or more similar questions, similar to that of the original question, previously submitted to the QA system by the one or more second users;
generating, by the QA system, one or more second candidate answers based on the one or more similar questions;
generating, by the QA system, a final answer based on the one or more first candidate answers and one or more second candidate answers; and
outputting, by the QA system, the answer to the user via the source device.

2. The method of claim 1, wherein the one or more second users are second users logically connected to the first user by a common context.

3. The method of claim 2, wherein the corpus of electronic content comprises a portion of electronic content associated with the common context.

4. The method of claim 3, wherein the first user profile comprises an identifier of a context associated with the first user, and wherein the method further comprises selecting the common context and the portion of electronic content associated with the common context based on the context identified in the first user profile.

5. The method of claim 4, wherein the first user profile comprises a plurality of identifiers of contexts associated with the first user, and wherein the common context is selected based on a correlation of features of the original question with an identified context in the first user profile.

6. The method of claim 2, wherein the common context comprises an online community with which the first user and the one or more second users are associated.

7. The method of claim 2, wherein the common context comprises at least one of electronic objects accessed by the first user and the one or more second users within a historical time frame, electronic communications exchanged between the first user and the one or more second users, or electronic communications exchanged between a plurality of the one or more second users.

8. The method of claim 1, wherein generating one or more second candidate answers based on the one or more similar questions comprises:
identifying one or more portions of the one or more similar questions that align with the personality trait of the first user; and
generating one or more supplemental queries based on the identified portions of the one or more similar questions.

9. The method of claim 8, wherein generating one or more second candidate answers based on the one or more similar questions further comprises performing an interactive exchange between the QA system and a client computing device of the first user that outputs a listing of the one or more portions to the first user and receives a selection from the first user of at least one portion in the one or more portion for use in generating supplemental queries, wherein the one or more supplemental queries are generated based on the selected at least one portion.

10. The method of claim 8, wherein generating one or more second candidate answers based on the one or more similar questions further comprises:
applying the one or more supplemental queries to the corpus to generate the one or more second candidate answers; and
generating a ranked listing of candidate answers comprising the one or more first candidate answers and the one or more second candidate answers.

11. A computer program product comprising a computer readable storage medium having a computer readable program stored therein, wherein the computer readable program, when executed on a data processing system implementing a Question and Answer (QA) system, causes the data processing system to:
receive, by the QA system, from a first user via a source device, an original question for processing by the QA system to generate an answer result;
retrieve, by the QA system, a first user profile associated with the first user, wherein the first user profile specifies a personality trait of the first user;
generate, by the QA system, one or more first candidate answers to the original question based on a search of a corpus of electronic content;
identify, by the QA system, one or more second users having a similar personality trait to the personality trait of the first user;
identify, by the QA system, one or more similar questions, similar to that of the original question, previously submitted to the QA system by the one or more second users;
generate, by the QA system, one or more second candidate answers based on the one or more similar questions;
generate, by the QA system, a final answer based on the one or more first candidate answers and one or more second candidate answers; and
output, by the QA system, the answer to the user via the source device.

12. The computer program product of claim 11, wherein the one or more second users are second users logically connected to the first user by a common context.

13. The computer program product of claim 12, wherein the corpus of electronic content comprises a portion of electronic content associated with the common context.

14. The computer program product of claim 13, wherein the first user profile comprises an identifier of a context associated with the first user, and wherein the computer readable program further causes the data processing system to select the common context and the portion of electronic content associated with the common context based on the context identified in the first user profile.

15. The computer program product of claim 14, wherein the first user profile comprises a plurality of identifiers of contexts associated with the first user, and wherein the common context is selected based on a correlation of features of the original question with an identified context in the first user profile.

16. The computer program product of claim 12, wherein the common context comprises an online community with which the first user and the one or more second users are associated.

17. The computer program product of claim 12, wherein the common context comprises at least one of electronic objects accessed by the first user and the one or more second users within a historical time frame, electronic communications exchanged between the first user and the one or more second users, or electronic communications exchanged between a plurality of the one or more second users.

18. The computer program product of claim 11, wherein the computer readable program further causes the data processing system to generate one or more second candidate answers based on the one or more similar questions at least by:
identifying one or more portions of the one or more similar questions that align with the personality trait of the first user; and
generating one or more supplemental queries based on the identified portions of the one or more similar questions.

19. The computer program product of claim 18, wherein the computer readable program further causes the data processing system to generate one or more second candidate answers based on the one or more similar questions at least by performing an interactive exchange between the QA system and a client computing device of the first user that outputs a listing of the one or more portions to the first user and receives a selection from the first user of at least one portion in the one or more portion for use in generating supplemental queries, wherein the one or more supplemental queries are generated based on the selected at least one portion.

20. An apparatus comprising:
a processor; and
a memory coupled to the processor, wherein the memory comprises instructions which, when executed by the processor, cause the processor to implement a Question and Answer (QA) system and perform the following operations:
receive, by the QA system, from a first user via a source device, an original question for processing by the QA system to generate an answer result;
retrieve, by the QA system, a first user profile associated with the first user, wherein the first user profile specifies a personality trait of the first user;
generate, by the QA system, one or more first candidate answers to the original question based on a search of a corpus of electronic content;
identify, by the QA system, one or more second users having a similar personality trait to the personality trait of the first user;
identify, by the QA system, one or more similar questions, similar to that of the original question, previously submitted to the QA system by the one or more second users;
generate, by the QA system, one or more second candidate answers based on the one or more similar questions;
generate, by the QA system, a final answer based on the one or more first candidate answers and one or more second candidate answers; and
output, by the QA system, the answer to the user via the source device.
